(19) United States
(12) Patent Application Publication
(10) Pub. No.: US 2025/0225810 A1
(43) Pub. Date: Jul. 10, 2025

(54) METHOD AND APPARATUS TO GENERATE AND AUGMENT DOCUMENT FORMS

(71) Applicant: Konica Minolta Business Soultions U.S.A., Inc., Foster City, CA (US)

(72) Inventor: Junchao WEI, San Mateo, CA (US)

(21) Appl. No.: 18/409,739

(22) Filed: Jan. 10, 2024

(51) Int. Cl. G06V 30/414; G06V 30/19; G06V 30/416

(52) U.S. Cl. CPC G06V 30/414; G06V 30/19147; G06V 30/416

(57) ABSTRACT

A deep learning based form generation and augmentation method and apparatus identifies regions on a form, and locates text within each of the regions. Bounding boxes may be placed around the located text. The bounding boxes may be randomly scaled or translated to generate new forms. In one aspect, semantic information is identified. Within a bounding box, the semantic information may be categorized. Similarly semantic information (e.g. names, dates, prices) may be identified from another source, and the categorized semantic information may be replaced by the semantic information from the other source as another aspect of generating the new forms.

### CROSS-REFERENCE TO RELATED APPLICATIONS

The present application is related to U.S. application Ser. No. 17/958,262, filed Sep. 30, 2022, entitled “Method and Apparatus for Form Identification and Registration”. The present application incorporates by reference this US application in its entirety. The present application also is related to U.S. application Ser. No. 18/128,951, filed Mar. 30, 2023, entitled “Method and Apparatus for Form Identification and Registration Employing Predefined Text Grouping’. The present application also incorporates by reference this US application in its entirety.

### BACKGROUND OF THE INVENTION

Generation of training data for deep learning systems that identify forms such as invoices has been challenging.

It would be desirable to be able to generate additional training data by augmentation of existing training data.

### SUMMARY OF THE INVENTION

Embodiments of the invention provide a method comprising:
responsive to receipt of an input form image, placing first bounding boxes around text in the form;
inputting semantic information for text in the bounding boxes;
using a deep learning system, identifying regions on the form, the regions to contain one or more of the bounding boxes;
using a deep learning system, performing one of randomly scaling or randomly translating one or more of the bounding boxes within at least one of the regions;
identifying first entities in a region containing semantic information;
replacing the identified first entities with second entities;
placing second bounding boxes around the text in the second entities; and
forming text images to generate training data for the or a deep learning system.

Embodiments of the invention provide an apparatus for performing the just-listed method.

### BRIEF DESCRIPTION OF THE DRAWINGS

FIG. 1 is an example of a form with fields that can be moved as part of form generation and augmentation;

FIG. 2 shows the form of FIG. 1 with indicators of possible field movement;

FIG. 3 shows one type of field movement for the fields in the form of FIG. 1;

FIG. 4 shows another type of field movement for the fields in the form of FIG. 1;

FIG. 5 shows yet another type of field movement for the fields in the form of FIG. 1;

FIG. 6 is a high level flow chart according to some embodiments;

FIG. 7 is a high level block diagram according to some embodiments;

FIG. 8 is a high level block diagram of portions of FIG. 7 according to an embodiment;

FIG. 9 is a high level block diagram of portions of FIG. 7 according to an embodiment.

### DETAILED DESCRIPTION

Embodiments of the invention provide a method comprising:
responsive to receipt of an input form image, placing first bounding boxes around text in the form;
inputting semantic information for text in the bounding boxes;
using a deep learning system, identifying regions on the form, the regions to contain one or more of the bounding boxes;
using a deep learning system, performing one of randomly scaling or randomly translating one or more of the bounding boxes within at least one of the regions;
identifying first entities in a region containing semantic information;
replacing the identified first entities with second entities;
placing second bounding boxes around the text in the second entities; and
forming text images to generate training data for the or a deep learning system.

Embodiments of the invention provide an apparatus for performing the just-listed method.

The above-mentioned patent applications disclose and describe examples of different forms with different fields. In the present application, one focus is on the fields, and on their manipulation within a form to generate forms as additional training data, or to augment the data in the form to provide more detail or granularity or other kind of information in the form.

In general, there are two types of information that can be changed and/or movable across forms. These information types may be considered to be in levels. A first level comprises the regions on the form, and the location of the regions relative to neighboring regions. In embodiments, the regions may include various kinds of semantic information. For example, a form region with the company address and/or the customer address may include the company name, company address, zip code, telephone number, and fax numbers. Some or all of these may be grouped, and can be moved together within a limited area of the form, after the identification of other regions on the form.

A second level comprises groups of digits, numbers, letters, words, as well as formatted numbers and words such as dates, addresses, names, and paired keyword and content in general. In an embodiment, in a form the keywords may be headers for tables on the form. Content may be the filled-in portions of the form, with the second level of information provided generally.

This information at one location can be modified using the collected similar items in a dictionary. For example, digits/numbers can be replaced by other digits/numbers, or letters/words can be replaced by other letters/words. Overall, by modifying and re-combining these two levels of information, it is possible to create a large number of new forms using the shared group of information or the similarities between the forms. As a result, training a large model without a substantial labeling cost and human labor is both feasible and practicable.

Following are aspects of a method to utilize and arrange the two levels of information to generate similar new forms and documents. First, a pre-grouped region may be examined to identify text bounding boxes within that region. Then, the text bounding boxes can be moved together freely and randomly within the confined area using a translation value which is calculated and constrained by the neighboring regions. This movement can be represented by a translation vector [u, v] which may be added to each bounding box coordinate [x, y] in that region. Also, the size of one or more of the regions can be changed slightly, for example, by scaling a region using values from [−0.x, 0.x}, which corresponds to up to x % scaling up or down for a given region. X may be a variety of numbers, such as 1, yielding plus or minus 10% scaling. Second, a second level of information, the semantic information for each bounding box, may be manipulated. For each bounding box's semantic information, a random candidate may be chosen from the named-entity group to replace it. Also, if a new entity is identified in that group, the new entity to the existing dictionary for the next target. For the digits, numeric and alphanumeric, each digit or letter from [0, 9] and [A, Z] or [a, z] alphabet randomly may be selected.

Human labeling may be necessary in order to identify pre-defined groups and sub-regions. As mentioned in the two patent applications listed above, there are eight pre-defined groups and sub-regions that are mentioned for the semantic model. The pre-defined groups and sub-regions may be hierarchical, and may be sorted from a highest level to a lowest level, as follows: (1) General Outer Region; (2) Header/Footer Fields; (3) Vertical Table; (4) Horizontal Table; (5) Paragraphs; (6) Columns; (7) Rows; and (8) Keywords.

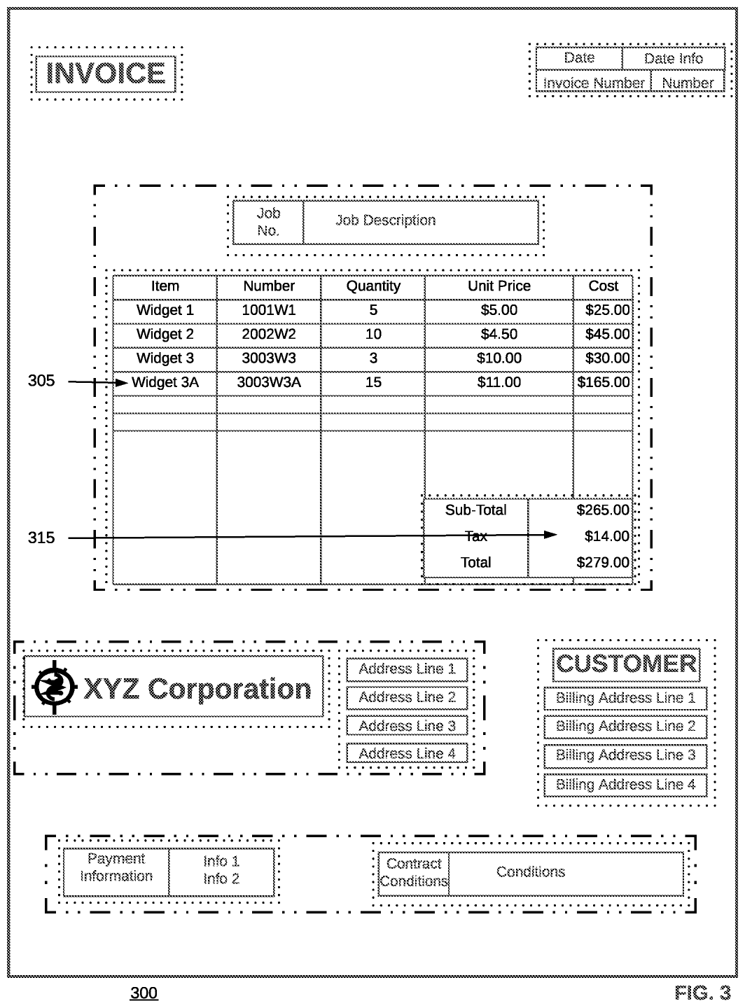

In an embodiment, during form generation and augmentation, each sub-region should be constrained and confined within its corresponding higher level region. For example, the header region may move within the general region, and the column or row regions should move within the vertical table or horizontal table region for the augmentations. In general, a higher sub-region may not move within a lower-level sub-region, but the prohibition need not be complete. Consequently, as FIGS. 3-5 (discussed later herein) show, a header field might be changed with a vertical or a horizontal table.

To accomplish named-entity level augmentation, first the span of candidate entity, may be selected. In an embodiment, the candidate entity may be selected from one of the following categories: (1) Keyword; (2) Content; (3) Person; (4) Location; (5) Organization; (6) Punctuation; (7) Number; (8) Alphabet; (9) Currency; (10) Date; (11) Telephone number; (12) Fax number; (13) Email address; (14) Item; and (15) Website (URL). The first two categories for the keyword and content may be used for the text spans and masks identification for replacement of one or more of the next 13 categories. After identifying the span, numbers and/or text can be replaced by the other classes from (3) to (15) using the dictionary and collection with the addition and growth if the candidate has not been found in it.

Overall, these form generation and augmentation approaches work well for general forms and documents so long as the user has established well-defined regions and semi-structures. In an embodiment, the user can define invariant regions in the labeling for both filled and unfilled forms. As a result, the model can learn bounded features such as keywords or content for the groups and regions. This approach provides at least the following benefits: (1) The approach enables efficient generation of similar regions for similar forms, it being necessary only to label once or define regions in one or two forms, whereupon similar forms may be generated automatically during training. (2) Form augmentation effectiveness increases as the number of labeling samples increases. The cumulative number of entities in the pre-defined dictionary will increase the variety and features for new forms. (3) It is possible to track and manage new generated samples, and without causing randomness and un-learnable features such as artifacts or noises that can decrease system performance later on.

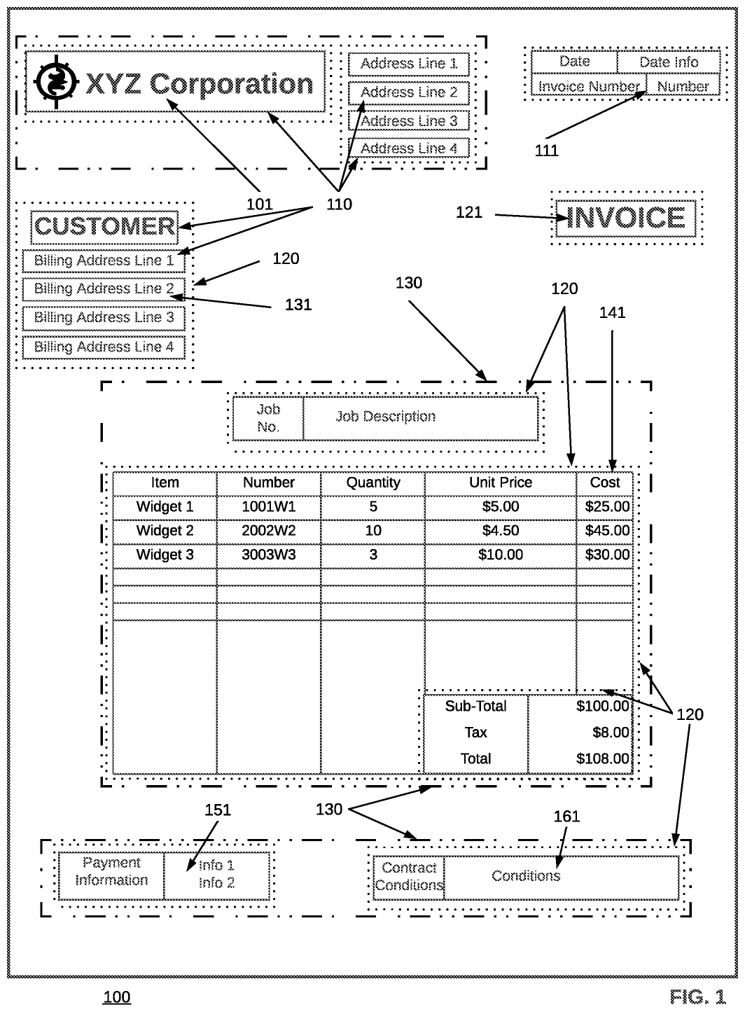

FIG. 1 shows a form 100 with original bounding boxes 110 pointed out. In FIG. 1, the solid lines around text denotes original bounding boxes. Field bounding boxes 120, which may surround more than one original bounding box 110, have dotted lines around them. Still larger field bounding boxes 130, which may surround more than one field bounding box 120, have chain lines around them.

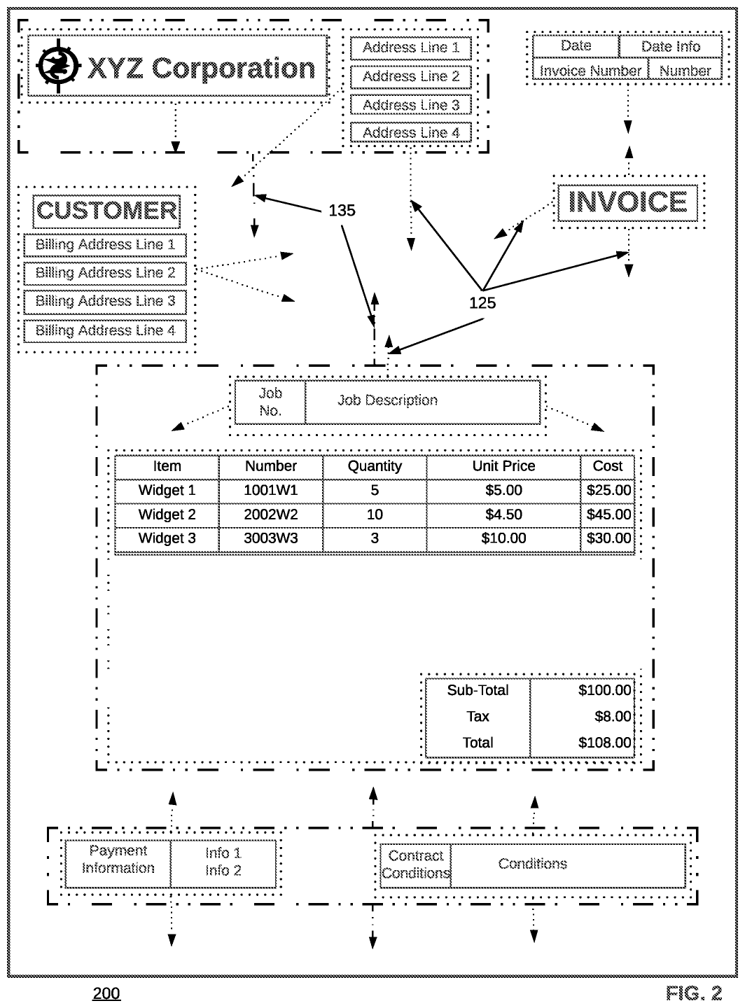

FIG. 2 shows a form 200 with arrows depicting possible directions of movement of the fields of the form of FIG. 1.

It should be noted that FIGS. 3-5, described below, show substantially complete flexibility among various fields to enable form generation and augmentation. Such flexibility theoretically may be possible, to enable generation of a wider range of training data. As a practical matter, however, in order to train a deep learning system appropriately, the changing of node weights in the deep learning system resulting from excessive flexibility of field movement can be significant, and can hinder, rather than help the training. Accordingly, when generating and/or augmenting forms it may be desirable to keep certain fields in place, to restrict movement of other fields to be within a more limited area. The resulting relatively minor changes in field movement may facilitate training of the deep learning system, with smaller changes in node weights.

In an embodiment, fields may be more limited in their movement. For example, the logo and corporate name in FIG. 1 might be moved solely along the top part of the form, instead of being moved to the bottom. Similarly, the corporate address and the customer name and address may be kept in particular areas of the form, for example, in the upper third of the form. Fields within an area having a table of values may be restricted in movement.

FIG. 3 shows a form 300 with the same fields as in FIG. 1 but with some of the fields moved. For example, the invoice field is moved to the other side of the form. The corporate name, logo, and address are moved lower down on the form, as are the customer name and billing address. The table in the middle of the form has a line 305 added for Widget 3A, with part number, quantity, unit price, and cost also provided. Because the cost changed, the figures in box 315 also changed. Depending on the embodiment, any one or more of the content, whether for one of the widgets, or the date, the invoice number, the addresses, etc. may be changed to provide different content in the form.

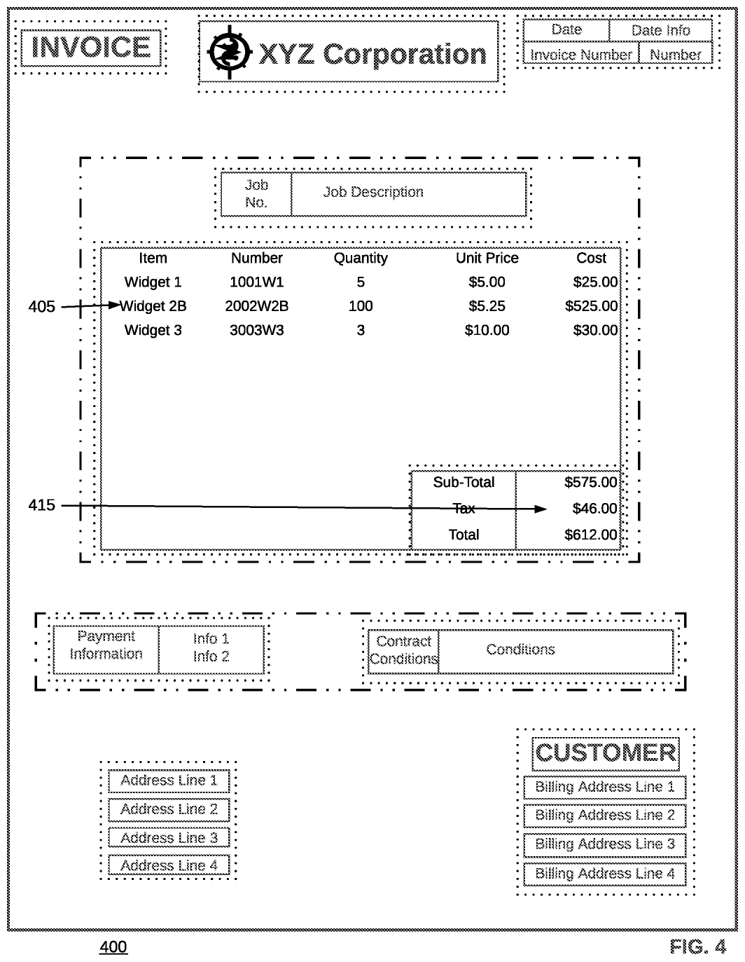

FIG. 4 shows a form 400 with the same fields as in FIG. 1 but with the field with the table moved to be higher on the form, as the corporate and customer address information are moved lower down to the bottom of the form. The invoice, corporate name and logo, and date and invoice number fields are moved higher on the form to accommodate upward movement of the field with the table. In FIG. 4, the table in the middle of the form has one of the lines replaced, with the item, part number, quantity, and cost changed. Because the cost changed, the figures in box 415 also changed. Again, depending on the embodiment, any one or more of the content, whether for one of the widgets, or the date, the invoice number, the addresses, etc. may be changed to provide different content in the form.

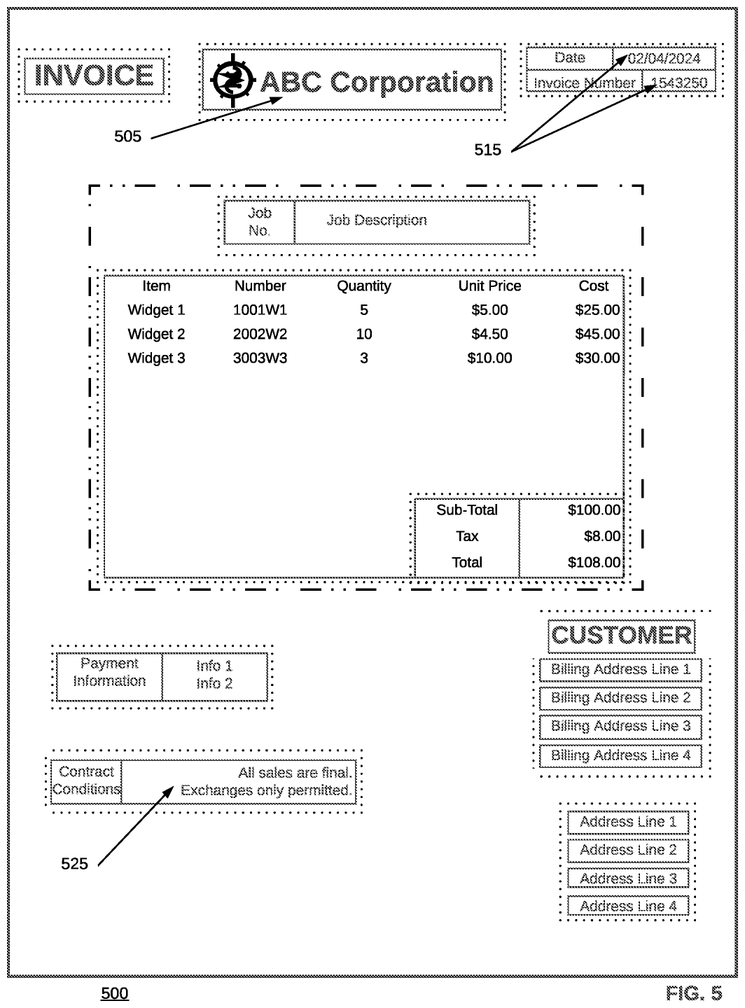

FIG. 5 shows a form 500 with other movement of fields, with the “Contract Conditions” field moved to the left to be below the “Payment Information” field. That field movement enables movement of the corporate and customer addresses toward the lower right hand side of the form, as FIG. 5 shows. Also in FIG. 5, the company name 505 has changed from XYZ Corporation to ABC Corporation. In addition, the date and invoice number 515 have changed. Still further, content for the keyword “contract conditions” near the bottom of form 500 is added. Here again, depending on the embodiment, any one or more of the content, whether for one of the widgets, or the date, the invoice number, the addresses, etc. may be changed to provide different content in the form.

While not specifically shown in the Figures, it is possible that additional forms could be generated with columns in the tables moved around. For example, the “Quantity” and “Unit Price” fields could be switched. In an embodiment, a horizontal table may be turned into a vertical table through manipulation of the columns.

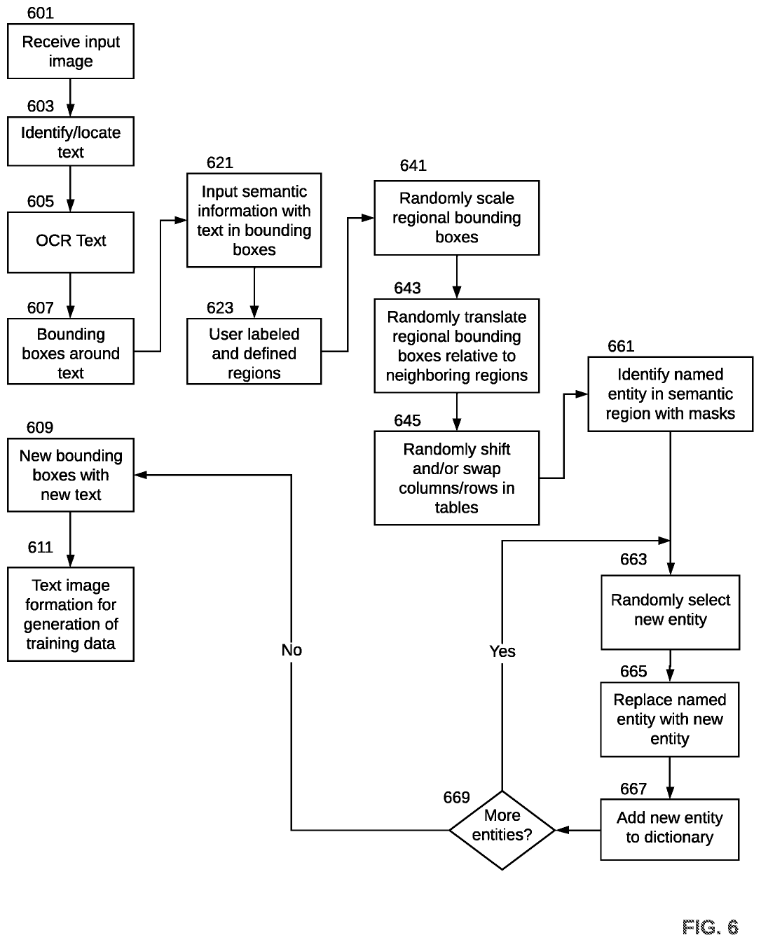

FIG. 6 shows a high level general flow of the inventive method and apparatus according to an embodiment. Ordinarily skilled artisans will appreciate the multi-modal approach to the training to be described. This multi-modal approach employs both bounding boxes (geometry of the various fields) and semantics (contents of the various fields).

In FIG. 6, at 601 an input image of a form is received. At 603, text spotting is performed (recognition of text in the image). Ordinarily skilled artisans will appreciate that there are various techniques for performing text spotting. After the text is spotted in the image, at 605 optical character recognition (OCR) is performed to identify the text. After OCR, at 607 bounding boxes are placed around the text. In some embodiments, the location of some of the bounding boxes relative to each other may indicate the presence of keywords (e.g. headers at the top of or on the side of a table) and content (actual contents in the table in columns under the headers, or in rows next to the headers).

From 607, flow proceeds to 621, where semantic information for the text in the bounding boxes (content of the bounding boxes) is input. Next, at 623, different regions in the input form may be identified, labeled, and defined. For example, the labels may be for a table, or a text paragraph, or a company field, or an address field, or a date field. Once these regions are defined, different fields (bounding boxes or groups of bounding boxes) may be moved around within their respective regions.

In an embodiment, at 641, bounding boxes within the identified regions may be located and, in some instances, scaled. In an embodiment, the scaling may be random, to facilitate generation of additional sample forms. In an embodiment, at 643, bounding boxes within a region may be moved around randomly relative to neighboring regions, again, to facilitate sample form generation. Depending on the embodiment, the bounding boxes may be at the top of the form, for example, and may be related to each other (for example, entries in a table), or may not be related to each other (for example, a date and a company logo and/or title). In an embodiment, at 645, if any of the bounding boxes contains a table, or if a group of bounding boxes defines a table, columns and rows may be shifted around and/or swapped. Ordinarily skilled artisans will appreciate that, for a table, bounding boxes for the table entries may be moved in unison (for example, one or more whole columns, one or more whole rows).

At 661, in a semantic region (for example, where there is a table, or address and/or other contact information), a particular piece of semantic information (for example, a date, a name of an industrial part, a telephone number, a street address, or the like) may be identified. (This piece of information also may be referred to as an entity.) A mask may be placed over that entity, signifying a date, a part name, a telephone number, a street address, or the like). Identifying the entity with a mask categorizes the piece of information. At 663, a dictionary may be consulted, and a matching, but different entity selected. At 665, the masked entity may be replaced with the selected entity, and the selected entity added to a dictionary as a new entity. With this addition, the selected entity may be used at some point later on as content in form generation.

663 to 667 are repeated, through 669, for every entity to be swapped. Once there are no more entities to be swapped, at 609 new bounding boxes may be placed around the new text (in the new entity). Then, at 611, an image of the new text may be formed to generate new training data.

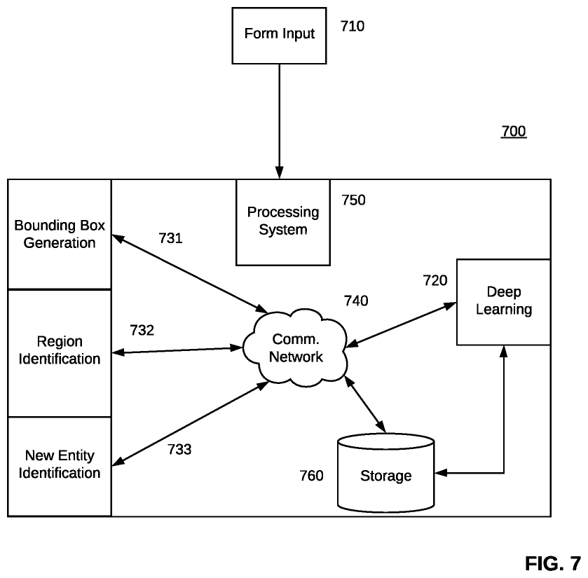

FIG. 7 is a high level block diagram of a computing system 700 which may implement a deep learning system 720, trained on known data as discussed above. Depending on the embodiment, form input 710 may take forms from any number of sources, including not only “live” sources such as scanners, cameras, or other imaging equipment which can provide images of known text sequences, but also “canned” sources such as libraries. In an embodiment, “live” sources as part of form input 710 also may handle text to be processed for electronic documents.

Processing system 750 may be a separate system, or it may be part form input 710, or may be part of deep learning system 720, depending on the embodiment. Processing system 750 may include one or more processors, one or more storage devices, and one or more solid-state memory systems (which are different from the storage devices, and which may include both non-transitory and transitory memory).

In an embodiment, processing system 750 may include deep learning system 720 or may work with deep learning system 720 to facilitate bounding box generation in block 731 (in an embodiment, for both existing and new text), or region identification in block 732, or new entity identification in block 733 in accordance with the various stages discussed above with respect to FIG. 6. In some embodiments, one or more of bounding box generation text orientation in block 731, or region identification in block 732, or new entity identification in block 733 may implement its own deep learning system 720. In embodiments, each of blocks 731, 732, or 733 may include one or more processors, one or more storage devices, and one or more solid-state memory systems (which are different from the storage devices, and which may include both non-transitory and transitory memory). In embodiments, additional storage 760 may be accessible to one or more of blocks 731, 732, or 733, and to processing system 750 over a communications network 740, which may be a wired or a wireless network or, in an embodiment, the cloud.

In an embodiment, storage 760 may contain training data for the one or more deep learning systems in one or more of blocks 720, 731, 732, 733, or 750. Storage 760 may store forms from form input 710.

Where communications network 740 is a cloud system for communication, one or more portions of computing system 700 may be remote from other portions. In an embodiment, even where the various elements are co-located, network 740 may be cloud-based.

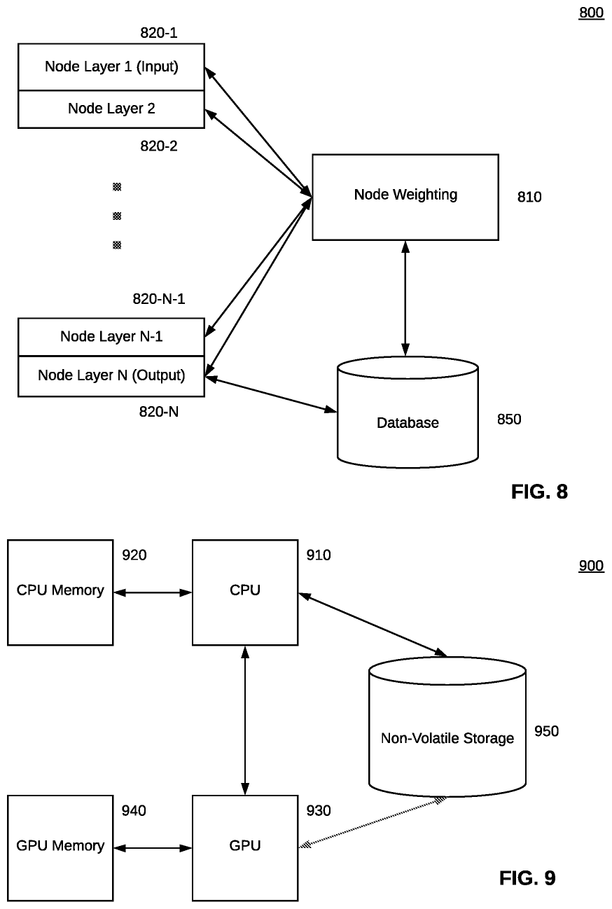

FIG. 8 is a high level diagram of apparatus 800 for weighting of nodes in a deep learning system according to an embodiment. As training of a deep learning system proceeds according to an embodiment, the various node layers 820-1, . . . , 820-N may communicate with node weighting module 810, which calculates weights for the various nodes, and with database 850, which stores weights and data. As node weighting module 810 calculates updated weights, these may be stored in database 850. This node weighting is part of any of the deep learning systems in FIG. 7, including deep learning system 720. As noted earlier, one or more of the blocks in computer system 700 may implement a deep learning system of its own, and hence may employ node weighting as in FIG. 8.

FIG. 9 is a high level diagram of apparatus 900 to operate a deep learning system according to an embodiment. In FIG. 9, one or more CPUs 910 may communicate with CPU memory 920 and non-volatile storage 950. One or more GPUs 930 may communicate with GPU memory 940 and non-volatile storage 850. Generally speaking, a CPU may be understood to have a certain number of cores, each with a certain capability and capacity. A GPU may be understood to have a larger number of cores, in many cases a substantially larger number of cores than a CPU. In an embodiment, each of the GPU cores may have a lower capability and capacity than that of the CPU cores, but may perform specialized functions in the deep learning system, enabling the system to operate more quickly than if CPU cores were being used.

In describing embodiments of the invention, the foregoing mentions forms. There may be embodiments in which some documents have sufficiently similar characteristics to forms that the techniques of the invention may be applicable to such documents.

While the foregoing describes embodiments according to aspects of the invention, the invention is not to be considered as limited to those embodiments or aspects. Ordinarily skilled artisans will appreciate variants of the invention within the scope and spirit of the appended claims.

What is claimed is:

1. A method comprising:
responsive to receipt of an input form image, placing first bounding boxes around text in the form;
inputting semantic information for text in the bounding boxes;
using a deep learning system, identifying regions on the form, the regions to contain one or more of the bounding boxes;
using a deep learning system, performing one of randomly scaling or randomly translating one or more of the bounding boxes within at least one of the regions;
identifying first entities in a region containing semantic information;
replacing the identified first entities with second entities;
placing second bounding boxes around the text in the second entities; and
forming text images to generate training data for the or a deep learning system.

2. The method of claim 1, wherein the input form comprises at least one table, the method further comprising randomly moving one or more columns and/or one or more rows within the table.

3. The method of claim 1, further comprising updating weights of nodes in the deep learning system being trained, responsive to one or more of said randomly scaling, said randomly translating, said replacing, or said forming.

4. The method of claim 1, further comprising performing text spotting in the input form image, and optical character recognition (OCR) on the input form image.

5. The method of claim 1, wherein there are first bounding boxes for all of the first entities.

6. The method of claim 1, wherein replacing the first entities comprises:
randomly selecting a second entity;
replacing a first entity with the second entity;
adding the second entity to a dictionary; and
repeating said randomly selecting, said replacing the first entity with the second entity, and said adding for all of the first entities.

7. The method of claim 1, wherein the randomly translating the one or more of the bounding boxes within one or more of the regions comprises, for a bounding box in a region, translating the bounding box only within said region.

8. The method of claim 1, wherein the randomly translating the one or more of the bounding boxes within one or more of the regions comprises, for a bounding box in a region, translating the bounding box from said region to another of the one or more of the regions.

9. The method of claim 1, wherein the randomly scaling comprises, for a bounding box in a region, enlarging or shrinking the bounding box.

10. The method of claim 9, further comprising enlarging or shrinking all of the bounding boxes in the region.

11. An apparatus comprising:
a deep learning system comprising at least one processor and a non-transitory memory that contains instructions that, when executed, enable the deep learning system to perform a method comprising:
responsive to receipt of an input form image, placing first bounding boxes around text in the form;
inputting semantic information for text in the bounding boxes;
using a deep learning system, identifying regions on the form, the regions to contain one or more of the bounding boxes;
using a deep learning system, performing one of randomly scaling or randomly translating one or more of the bounding boxes within at least one of the regions;
identifying first entities in a region containing semantic information;
replacing the identified first entities with second entities;
placing second bounding boxes around the text in the second entities; and
forming text images to generate training data for the or a deep learning system.

12. The apparatus of claim 11, wherein the input form comprises at least one table, the method further comprising randomly moving one or more columns and/or one or more rows within the table.

13. The apparatus of claim 11, wherein the method further comprises updating weights of nodes in the deep learning system being trained, responsive to one or more of said randomly scaling, said randomly translating, said replacing, or said forming.

14. The apparatus of claim 11, wherein the method further comprises performing text spotting in the input form image, and optical character recognition (OCR) on the input form image.

15. The apparatus of claim 11, wherein there are first bounding boxes for all of the first entities.

16. The apparatus of claim 11, wherein replacing the first entities comprises:
randomly selecting a second entity;
replacing a first entity with the second entity;
adding the second entity to a dictionary; and
repeating said randomly selecting, said replacing the first entity with the second entity, and said adding for all of the first entities.

17. The apparatus of claim 15, wherein the randomly translating the one or more of the bounding boxes within one or more of the regions comprises, for a bounding box in a region, translating the bounding box only within said region.

18. The apparatus of claim 13, wherein the randomly translating the one or more of the bounding boxes within one or more of the regions comprises, for a bounding box in a region, translating the bounding box from said region to another of the one or more of the regions.

19. The apparatus of claim 11, wherein the randomly scaling comprises, for a bounding box in a region, enlarging or shrinking the bounding box.

20. The apparatus of claim 19, wherein the method further comprises enlarging or shrinking all of the bounding boxes in the region.
